(19) United States
(12) Patent Application Publication
(10) Pub. No.: US 2017/0259902 A1
(43) Pub. Date: Sep. 14, 2017

(54) Aircraft Aerodynamic Surface With A Detachable Leading Edge

(71) Applicant: Airbus Operations, S.L., Getafe (Madrid) (ES)

(72) Inventors: Pablo Cebolla Garrofe, Madrid (ES); Iker Vélez De Mendizabal Alonso, Madrid (ES); Soledad Crespo Peña, Madrid (ES); Álvaro Calero Casanova, Madrid (ES); Carlos García Nieto, Madrid (ES); Enrique Guinaldo, Madrid (ES); Francisco Javier Honorato Ruiz, Madrid (ES); Álvaro Torres Salas, Madrid (ES)

(73) Assignee: Airbus Operations, S.L., Getafe (Madrid) (ES)

(21) Appl. No.: 15/452,899

(22) Filed: Mar. 8, 2017

(30) Foreign Application Priority Data
Mar. 10, 2016 (EP) 16382106.9

(51) Int. Cl. B64C 3/26; B64C 5/02; B64C 3/18

(52) U.S. Cl. CPC B64C 3/26; B64C 3/185; B64C 5/02

(57) ABSTRACT

An aircraft aerodynamic surface includes a torsion box having an upper skin, a lower skin, and a front spar, and a leading edge having an external shell and an impact resisting structure. The external shell may be shaped with an aerodynamic leading edge profile, being configured to provide Laminar Flow Control (LFC) to the leading edge. The impact resisting structure is spanwise arranged between the external shell and the front spar, and is configured for absorbing a bird strike to prevent damage in the front spar. Also, at least one of the external shell and the impact resisting structure is fitted with the upper and lower skins of the torsion box to thereby facilitate leading edge exchange.

### FIELD OF THE INVENTION

The present invention refers to an aircraft aerodynamic surface with a detachable leading edge configuration so as to provide an aerodynamic surface with dissociated functionalities.

An aspect of the present invention may provide an aerodynamic surface for an aircraft with dedicated and improved components for its aerodynamic and structural functionalities.

Another aspect of the present invention may provide an aerodynamic surface for an aircraft that is easily interchangeable to facilitate the maintainability and reparability of the same.

Another aspect of the present invention may provide an aerodynamic surface for an aircraft that minimizes the cost and damage in a bird strike event.

### BACKGROUND OF THE INVENTION

Bird-plane collisions during flight, take-off and landing happen every day, jeopardizing people and aircraft integrity.

Certification regulations governing certain categories of aircraft require that, in the event of damage to a component caused by collision with a bird, the aircraft has to be capable of maintaining flight long enough to reach a landing site.

For that, conventional aircraft lifting surfaces are configured to both withstand the bird strikes and fulfilling the aerodynamic requirements.

This integration of these both functionalities results in a secured, but complicated attachment to the aircraft.

Aircraft aerodynamic surfaces, such as wings or stabilizers (a Horizontal Tail Plane (HTP) or a Vertical Tail Plane (VTP), comprises leading edges typically consisting of outer and inner skins joined by lateral walls forming a cavity system therebetween.

In a bird strike event, these aerodynamic surfaces require a complete replacing of the leading edge, if the skins are bonding to each other, or an outer skin replacing if said outer skin is riveted to the inner skin.

FIG. 1 shows different views of a leading edge 1 formed by an outer skin 5, an inner skin 3, and a set of transversal walls 6 fixed to the outer and inner skins 3, 5 at specific locations to form chambers 2 of different sizes. FIG. 1a shows a perspective view of the leading edge 1, and FIGS. 1b and 1c show different transversal walls configurations.

According to this, bird collisions demands long time for interchanging and/or repairing the collided pieces.

### BRIEF SUMMARY OF THE INVENTION

Therefore, there is a need for simplifying the reparability and maintainability tasks of the aircraft aerodynamic surfaces in a bird collision event. Also, there is a need for reducing the costs caused by these bird collisions.

The present invention relates to an aircraft aerodynamic surface, such as a wing or a stabilizer (HTP or VTP), having a detachable leading edge.

The invention relates to an aircraft aerodynamic surface comprising a torsion box having an upper skin, a lower skin, and a front spar, and a leading edge having an external shell and an impact resisting structure.

The external shell is shaped with an aerodynamic leading edge profile. The impact resisting structure is spanwise arranged between the external shell and the front spar of the aerodynamic surface, and it is configured for absorbing a bird strike.

Thus, the external shell fulfills the aerodynamic functionalities, and the impact resisting structure fulfills the structural requirements. This way, the aerodynamic surface of the invention is formed by an optimized structure for each one of the aerodynamic and structural functionalities.

The external shell can be shaped so as to provide Hybrid Laminar Flow Control (HLFC). For that, the external shell comprises a perforated outer skin, a perforated inner skin internally arranged with respect to the outer skin, and a plurality of suction chambers formed between the outer and inner skins and extending spanwise, such as the exterior region of the leading edge is communicated with an interior region of the leading edge through said suction chambers. Thus, apart from fulfilling aerodynamic requirements, the external shell may fulfil antierosion demands and provide Hybrid Laminar Flow Control (HLFC) functionality.

The impact resisting structure is specially configured for withstanding a bird strike. Thus, the front spar of the torsion box is prevented from being damaged, which means that the impact resisting structure is designed (calculated), such as in the event of a bird strike, said structure would act as a bumper protecting the front spar from any damage.

To finally form the aerodynamic surface, at least one of the external shell and the impact resisting structure is fitted with the upper and lower skins of the torsion box to thereby facilitate leading edge exchange. Thus, a wing, an HTP or a VTP with a detachable leading edge is provided.

An aspect of the invention provides a two-part aerodynamic surface with dissociated functionalities, thus optimizing the performance of each functionality.

The invention offers a simple and cost-effective solution for the maintainability and reparability of leading edges, since the proposed leading edge can be easily replaced in a bird strike event.

Further, in case of HLFC aerodynamic surfaces, the HLFC functionality can be easily and economically maintain by just replacing the external shell.

Thus, some of the advantages of the invention are:
Cost saving:
   very low cost of an HLFC external shell due to the structural bird impact requirements are avoided,
   the impact resisting capability is only provided to an internal structure, not to the entire leading edge,
   Plug and play in service solution. Only replacement of a cheap external shell, and in the worst case, the replacement of a detachable leading edge.
   Potential weight saving. Dedicated and optimized structures for each functionality of the leading edge.

### BRIEF DESCRIPTION OF THE DRAWINGS

Preferred embodiments of the invention are henceforth described with reference to the accompanying drawings, in which:

FIGS. 1a-1c show different views of conventional designs of leading edge sections with laminar flow control. FIG. 1a is a perspective view, FIG. 1b is an enlarged view of a detail of FIG. 1a, and FIG. 1c is an enlarged view of a detail of FIG. 1a according to another configuration.

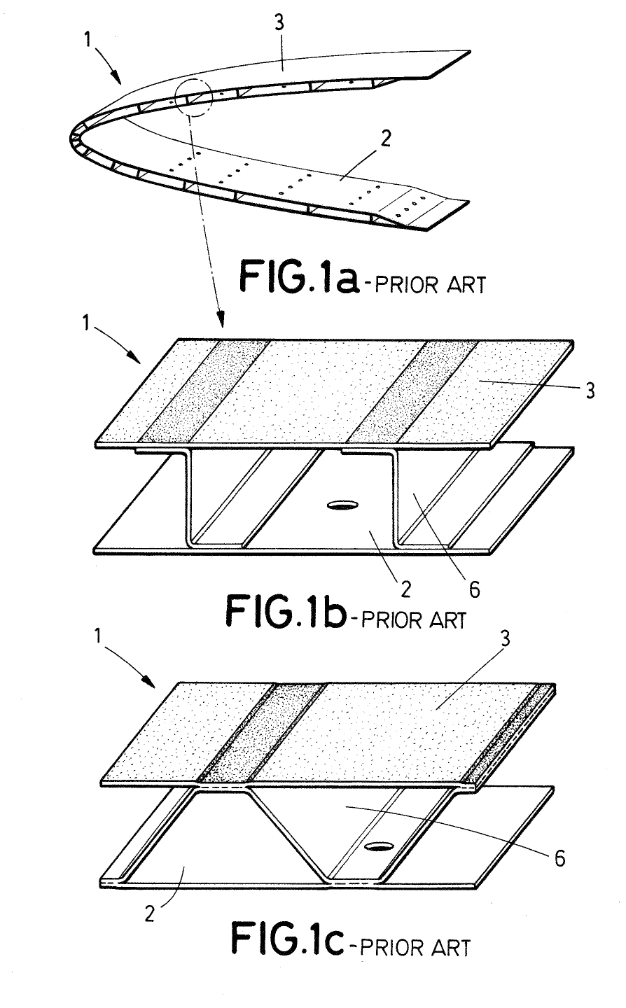

FIGS. 2a-2e show different schematic cross-sectional views of the aircraft aerodynamic surface according to an embodiment of the invention. FIGS. 2a-2c show an aerodynamic surface having an impact resisting structure that comprises a rear and a front piece according to three embodiments. FIGS. 2d, 2e show an aircraft aerodynamic surface having an impact resisting structure formed by only one piece according to other embodiments.

FIGS. 3a-3f show different schematic cross-sectional views of different attachments possibilities between the leading edge, and the upper and lower skins of the torsion box of the aircraft.

FIGS. 4a, 4b show a multi-chamber configuration of a leading edge section of a wing or lifting surface with laminar flow control, wherein FIG. 4a is a perspective view, and FIG. 4b is an enlarged cross-sectional view of FIG. 4a.

### DETAILED DESCRIPTION

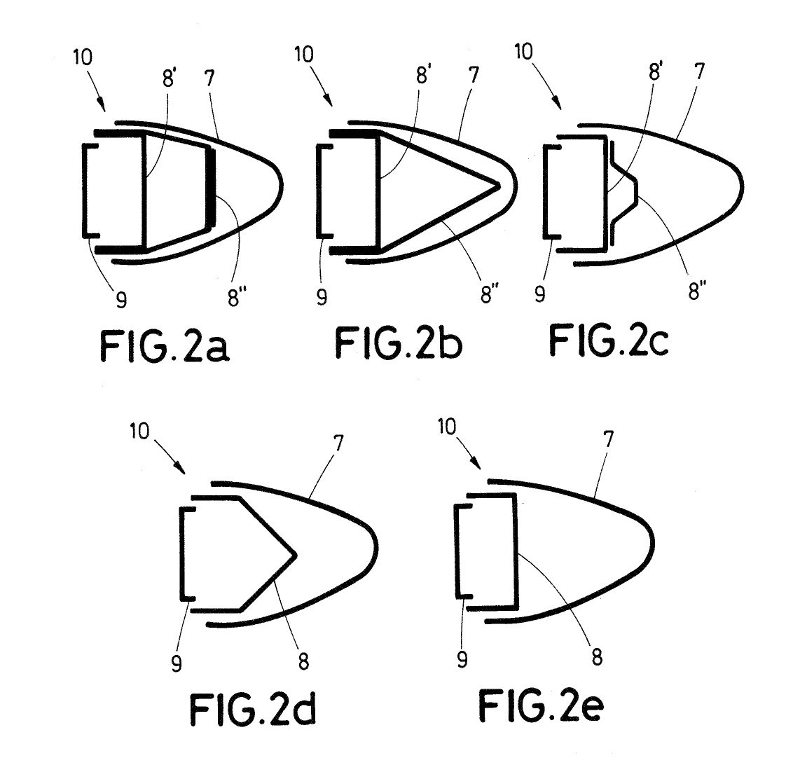

FIGS. 2a-2e show different embodiments of the aircraft aerodynamic surface of the invention.

Conventionally, the aircraft aerodynamic surface 10 comprises an upper skin 11, a lower skin 12, and a front spar 9. According to the invention, the aircraft aerodynamic surface 10 comprises a leading edge 1 formed by an external shell 7 and an impact resisting structure 8, wherein at least one of the external shell 7 and the impact resisting structure 8 is fitted with the upper and lower skins 11, 12 of the torsion box.

The impact resisting structure 8 is spanwise arranged between the external shell 7 and the front spar 9 of the torsion box, and is configured for absorbing a bird strike to prevent damage in the front spar 9 and withstand aerodynamic load.

FIGS. 2a, 2b and 2c show an aircraft aerodynamic surface 10 comprising an impact resisting structure 8 formed by a rear piece 8′ and a front piece 8″. The rear piece 8′ is positioned near the front spar 9, and the front piece 8″ near the external shell 7.

Providing a two-piece impact resisting structure 8, the invention provides a further protection against bird strikes. In a preferred embodiment, the front piece 8″ is projected toward the external shell 7, covering most part of the space between the impact resisting structure 8 and the external shell 7. This way, a further structural protection is provided in the chord wise direction of the leading edge.

FIG. 2a shows an aircraft aerodynamic surface 10 having an impact resisting structure 8 formed by a C-shaped profile rear piece 8′ and an omega profile front piece 8″.

FIG. 2b shows an aircraft aerodynamic surface 10 having an impact resisting structure 8 formed by a C-shaped profile rear piece 8′ and a triangular profile front piece 8″.

FIG. 2c shows an aircraft aerodynamic surface 10 having an impact resisting structure 8 formed by a C-shaped profile rear piece 8′ and an omega profile front piece 8″.

According to a preferred embodiment, the rear and the front pieces 8′, 8″ are both extended between the upper and the lower skins 11, 12, to reinforce the entire leading edge 1.

According to another preferred embodiment, the rear and the front pieces 8′, 8″ are joining together forming a unitary component. This way, the invention provides a more robust impact resisting structure 8.

FIGS. 2d and 2e show an aircraft aerodynamic surface 10 comprising an impact resisting structure 8 formed by one piece.

FIGS. 2d and 2e show an aircraft aerodynamic surface 10 having an impact resisting structure 8 respectively having a triangular and C-shaped profile, respectively. In both cases, the impact resisting structure 8 is extended between the front spar 9 and the external shell 7 to cover most part of the space between the impact resisting structure 8 and the external shell 7.

According to an embodiment of the invention, at least one of the external shell 7 and the impact resisting structure 8 are fitted with the upper and lower skins 11, 12 of the torsion box to facilitate leading edge 1 exchange. This way, the invention provides an aerodynamic surface with a plug and play leading edge, which simplifies and reduces the costs of the leading edge exchange.

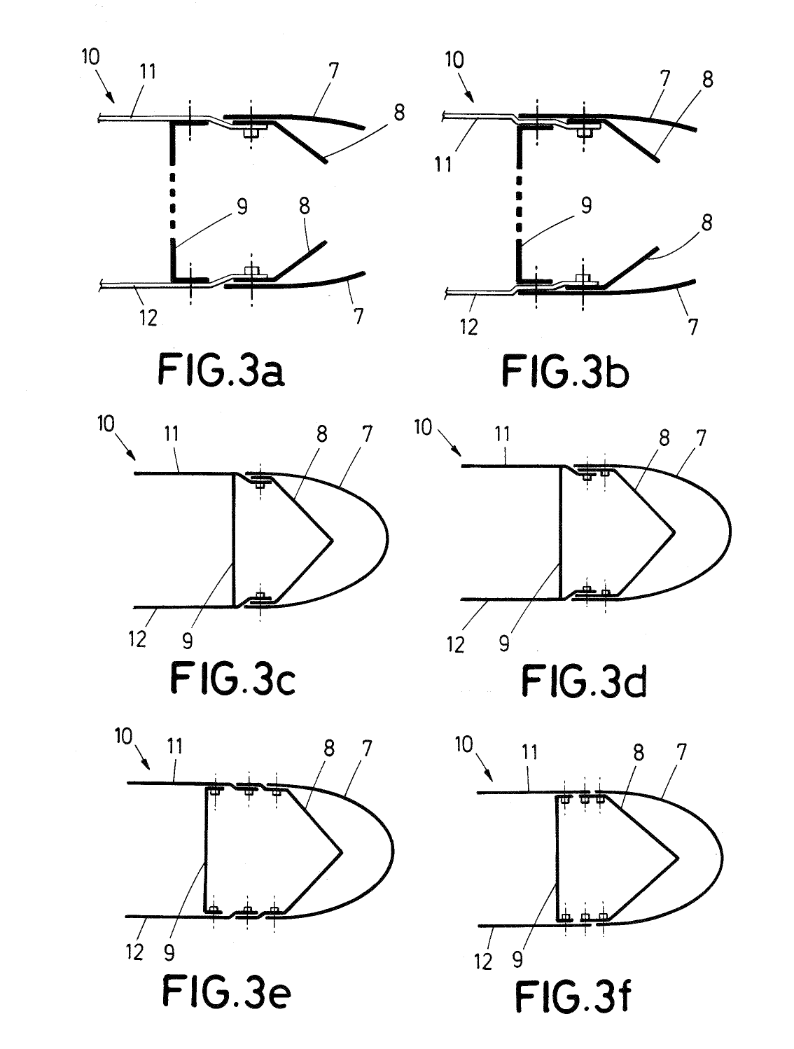

FIGS. 3a-3f show different attachments for the external shell 7, the impact resisting structure 8, the upper and lower skins 11, 12, and the front spar 9.

In FIGS. 3a, 3b, 3c and 3d the external shell 7 and the impact resisting structure 8 are fitted together with the upper and lower skins 11, 12 of the torsion box.

FIG. 3a shows a preferred embodiment, wherein the front spar 9 is further fitted to the upper and lower skins 11, 12 of the torsion box. By fitting the leading edge 1 to an internal structural component of the torsion box, such as the front spar 9, the invention achieves a leading edge with a secure attachment.

FIG. 3b shows an alternative preferred embodiment, wherein the external shell 7 is further coupled to both the front spar 9 and the upper and lower skins 11, 12 of the torsion box. This way, the leading edge is more firmly connected to the main body of the aerodynamic surface 10.

FIGS. 3c and 3d show alternative embodiments in which the front spar 9 is integrated in the torsion box, forming a piece with its upper and lower skins 11, 12.

FIG. 3c shows an embodiment having only one attachment, in which the external shell 7 and the impact resisting structure 8 are fitted together with the upper and lower skins 11, 12 of the torsion box.

FIG. 3d shows another embodiment having two attachments at each upper and lower skins 11, 12 of the torsion box, in which in a first attachment, the external shell 7 and the impact resisting structure 8 are fitted together, and in which in a second attachment, the external shell 7 and the impact resisting structure 8 are fitted together with the upper and lower skins 11, 12 of the torsion box.

When only one attachment is provided, this attachment has to be detachable, while when more than one attachment is provided, at least one of them has to be detachable.

FIGS. 3e and 3f show an alternative embodiment having three attachments, a first attachment in which the external shell 7 and the impact resisting structure 8 are fitted together, a second attachment in which the impact resisting structure 8 and the upper and lower skins 11, 12 are fitted together, and a third attachment in which the upper and lower skins 11, 12 and the front spar 9 are fitted together.

In FIGS. 3a-3e the attachments are formed by an outermost external shell 7, an intermediate impact resisting structure 8, and an inwardly positioned skin 11, 12. In FIG. 3e where components are fitted by pairs, the above indicated scheme is also followed. As seen, the external shell 7 is exterior to the impact resisting structure 8, and said impact resisting structure 8 is exterior to the skins 11, 12.

Alternatively, in FIG. 3f, the external shell 7 and the upper or lower skins 11, 12 are equally shaped, such that the attachment of the impact resisting structure 8 and the upper or lower skins 11, 12 are formed by an exterior skin and an inner impact resisting structure 8.

According to a preferred embodiment, the external shell 7 comprises a perforated outer skin 3, a perforated inner skin 5, and a plurality of suction chambers 2 formed between the outer and inner skins 3, 5.

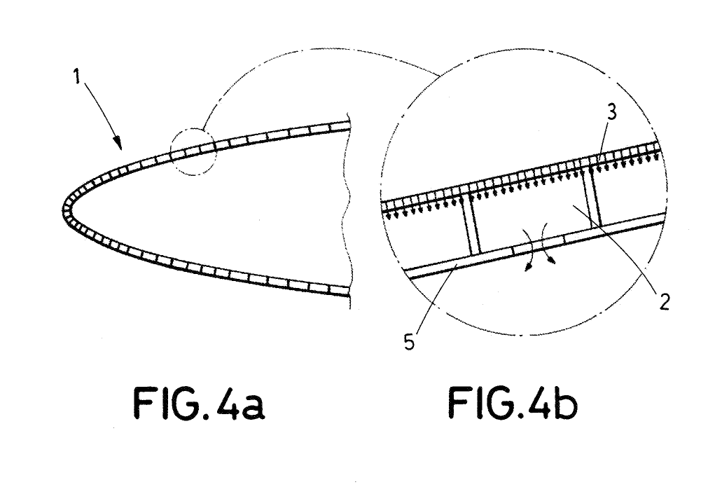

As shown in FIGS. 4a, 4b, the outer and inner skins 3, 5 are shaped with an aerodynamic leading edge profile. The inner skin 5 is internally arranged with respect to the outer skin 3. The suction chambers 2 allow the exterior region of the leading edge 1 is communicated with an interior region of the leading edge 1. This way, the external shell 7 is configured for providing HLFC functionality.

HLFC configuration increases the aircraft performance and reduces fuel consumption, by reducing the aerodynamic drag on its surfaces.

Finally, according to another aspect of the present invention, the invention further comprises an aircraft comprising the aerodynamic surface 10 as described.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft aerodynamic surface comprising:
a torsion box having an upper skin, a lower skin, and a front spar; and
a leading edge having an external shell and an impact resisting structure,
the external shell being shaped with an aerodynamic leading edge profile,
wherein the impact resisting structure is spanwise arranged between the external shell and the front spar,
wherein said impact resisting structure is configured for absorbing a bird strike to prevent damage in the front spar, and
wherein at least one of the external shell and the impact resisting structure is fitted together with the upper and lower skins of the torsion box to thereby facilitate leading edge exchange.

2. The aircraft aerodynamic surface, according to claim 1, wherein the external shell comprises:
a perforated outer skin;
a perforated inner skin internally arranged with respect to the outer skin; and
a plurality of suction chambers formed between the outer and inner skins, such as the exterior region of the leading edge is communicated with an interior region of the leading edge through said suction chambers.

3. The aircraft aerodynamic surface, according to claim 1, wherein the impact resisting structure comprises a rear piece and a front piece, the rear piece arranged close to the front spar, and the front piece arranged close to the external shell.

4. The aircraft aerodynamic surface, according to claim 3, wherein the rear and the front pieces are both extended between the upper and the lower skins to provide a leading edge reinforcement in a bird strike event.

5. The aircraft aerodynamic surface, according to claim 3, wherein the rear piece has a C-shaped profile, and the front piece has an omega, or a triangular, or a parallelepiped shaped profile projecting towards the external shell covering most part of the space between the impact resisting structure and the external shell.

6. The aircraft aerodynamic surface, according to claim 3, wherein the rear and the front pieces are joining together forming a unitary component.

7. The aircraft aerodynamic surface, according to claim 1, wherein the impact resisting structure has a C-shaped or a triangular shaped profile projecting towards the external shell covering most part of the space between the impact resisting structure and the external shell.

8. The aircraft aerodynamic surface, according to claim 1, wherein the front spar is fitted to the upper and lower skins of the torsion box.

9. The aircraft aerodynamic surface, according to claim 8, wherein the external shell is further fitted to both the front spar and the upper and lower skins of the torsion box.

10. The aircraft aerodynamic surface, according to claim 1, wherein the aerodynamic surface is a wing, or a HTP, or a VTP.

11. An aircraft comprising an aerodynamic surface comprising:
a torsion box having an upper skin, a lower skin, and a front spar; and
a leading edge having an external shell and an impact resisting structure,
the external shell being shaped with an aerodynamic leading edge profile,
wherein the impact resisting structure is spanwise arranged between the external shell and the front spar,
wherein said impact resisting structure is configured for absorbing a bird strike to prevent damage in the front spar, and
wherein at least one of the external shell and the impact resisting structure is fitted together with the upper and lower skins of the torsion box to thereby facilitate leading edge exchange.
